(19) United States
(12) Patent Application Publication
(10) Pub. No.: US 2014/0022489 A1
(43) Pub. Date: Jan. 23, 2014

(54) BACKLIGHT MODULE AND LCD DEVICE

(71) Applicants: Shihhsiang Chen, Shenzhen (CN); Gege Zhou, Shenzhen (CN)

(72) Inventors: Shihhsiang Chen, Shenzhen (CN); Gege Zhou, Shenzhen (CN)

(21) Appl. No.: 13/582,422

(22) PCT Filed: Jul. 23, 2012
(86) PCT No.: PCT/CN2012/079008

§ 371 Date: Sep. 2, 2012

(30) Foreign Application Priority Data
Jul. 19, 2012 (CN) 201210250527.0

(51) Int. Cl. G09F 13/18; G02F 1/1335

(52) U.S. Cl. CPC G09F 13/18; G02F 1/133615
USPC 349/62; 362/628

(57) ABSTRACT

The backlight module comprises a backplane and a light guide plate arranged in the backplane. The backlight module also comprises a limiting member for limiting the light guide plate. The limiting member comprises a horizontal limiting structure. The horizontal limiting structure abuts against an edge of the light guide plate and a side wall of the backplane. A limiting member is arranged between the edge of the light guide plate and the side wall of the backplane. One side of the limiting member abuts against the light guide plate, and the other side of the limiting member abuts against the side wall of the backplane. The limiting member is used for filling in a gap from the side wall of the backplane to the edge of the light guide plate. Thus, the horizontal limiting of the light guide plate by directly using the limiting member is achieved.

### TECHNICAL FIELD

The present disclosure relates to the field of liquid crystal displays (LCDs), and more particularly to a backlight module and a fixing piece for fixing a light guide plate.

### BACKGROUND

As a key component of an LCD device, a backlight module is mainly used for providing sufficient brightness and uniformly distributed light sources to enable an LCD panel to normally display images.

As shown in FIG. 1, an LCD module of an LCD device includes: a backplane 10, a reflector plate 41 arranged in the backplane 10, a light guide plate 40 arranged on the reflector plate 41, an optical film 30 arranged on the light guide plate 40, and a middle frame 60 which is arranged outside the backplane 10 and is used for pressing the light guide plate 40 to limit a vertical position of the light guide plate 40. The middle frame 60 is also used for carrying an LCD panel 50 and providing a limiting structure for limiting the horizontal position of the LCD panel 50. A front frame 20 is used for pressing the LCD panel 50 to limit the vertical position of the LCD panel 50.

As shown in FIG. 1, the front frame 20, the middle frame 60 and the backplane 10 in the backlight module of the LCD module respectively have different functions. The backplane 10 carries all components and ensures a planeness of the backlight module. The middle frame 60 mainly carries the LCD panel 50, limits the vertical position of the light guide plate 40, and also blocks light leakage. The front frame 20 is mainly matched with the middle frame 60 to limit the vertical position of the LCD panel 50 and prevent the LCD panel 50 from dropping, the horizontal fixation of the light guide plate 40 is realized mainly through a riveting column 70. However, when the backlight module is subject to a vibration, the light guide plate 40 may contact the riveting column 70, and may also rupture the light guide plate 40.

U.S. patent applicant Ser. No. 13/376,657 puts forward a scheme to reduce contact of the light guide plate 40 by the riveting column. However, the riveting column mentioned above is still used for limiting the light guide plate 40, so that a manufacture of the backplane becomes complicated, and cost is not easy to reduce.

### SUMMARY

In view of the above-described problems, an aim of the present disclosure is to provide a backlight module with a simple positioning structure of a light guide plate and an LCD device.

A purpose of the present disclosure is achieved by the following technical schemes: A backlight module comprises: a backplane, a light guide plate arranged in the backplane, and a limiting member for limiting the light guide plate. The light guide plate is of a rectangular-shaped structure. An edge of the light guide plate is flat. The limiting member comprises a horizontal limiting structure and a vertical limiting structure. The horizontal limiting structure is configured with a limiting plane. The limiting plane of the horizontal limiting structure abuts against the edge of the light guide plate. The other side of the horizontal limiting structure abuts against a side wall of the backplane. The vertical limiting structure abuts against a light emitting surface of the light guide plate. The horizontal limiting structure of the limiting member is configured with an elastic buckle relative to one side of the side wall of the backplane. The side wall of the backplane is configured with a clamping hole. The limiting member is clamped into the clamping hole on the backplane through the elastic buckle on the limiting member.

The purpose of the present disclosure is also achieved by the following technical scheme: a backlight module comprises: a backplane and a light guide plate arranged in the backplane, and also comprises a limiting member for limiting the light guide plate. The limiting member comprises a horizontal limiting structure. The horizontal structure abuts against an edge of the light guide plate and a side wall of the backplane.

The light guide plate is of a rectangular-shaped structure. The edge of the light guide plate is flat. The horizontal limiting structure has a limiting plane. The limiting plane comes into surface contact with the edge of the light guide plate. Because the limiting plane of the horizontal limiting structure conies into surface contact with the edge of the light guide plate, the local pressure of the horizontal limiting structure on the edge of the light guide plate is reduced. Thus, the pressure of a limiting component on the light guide plate is alleviated without arranging the structure of a groove or other structures. For a riveting column, because the contact area of the riveting column with the light guide plate is small, the edge of the light guide plate is easy to damage if the riveting column is directly arranged on the flat edge of the light guide plate. Thus, the groove is required to be arranged for alleviating the pressure of the riveting column on the light guide plate. For the scheme, the groove is not arranged on the light guide plate for matching with the limiting of the limiting member. Cutting on the light guide plate is avoided. The fragile part of the groove of the light guide plate is prevented from being smashed caused by collision of the backlight module with a structure of the riveting column and the groove due to vibration when the light guide plate is in a collision test or is collided during using, avoiding affecting the optical performance of the light guide plate.

The limiting member further comprises a vertical limiting structure. The vertical limiting structure abuts against the light emitting surface of the light guide plate. The vertical limiting of the light guide plate is realized by using the vertical limiting structure combined with the backplane, so that three positions of the light guide plate are all limited and fixed in the backlight module. The function of the middle frame for compacting the light guide plate is replaced. Thus, in the structure of the backlight module, the structure of the middle frame can also be simplified or the design of the middle frame can be directly omitted.

The vertical limiting structure of the limiting member is also configured with a limiting lug head to limit the horizontal position of the LCD panel of the LCD device. The vertical limiting structure is used for carrying the LCD panel. The limiting lug head is used for limiting the edge of the LCD panel. A limit of the horizontal position of the LCD panel of the LCD device is realized through the limiting lug head. Thus, the support and the limiting of the middle frame for the LCD panel are directly replaced. Then, the design of the middle frame can be directly omitted from the design of the LCD device, thereby favoring narrow frame design of the LCD device.

The limiting member is configured with a fixing structure for fixing the limiting member to the backplane. The installation of the limiting member is more reliable, and the limiting member can be directly fixed to the backplane in the absence of the front frame.

The fixing structure is an elastic buckle arranged on the horizontal limiting structure of the limiting member relative to one side of the side wall of the backplane. The side wall of the backplane is configured with a clamping bole The limiting member is clamped into the clamping hole on the backplane through the elastic buckle on limiting structure. The fixation of the limiting member is realized by matching the buckle with the clamping hole. The limiting member has a simple structure and is convenient for installation. The limiting member is only required to be pressed down.

The limiting member is an L-shaped plate-shaped member. The horizontal limiting structure and the vertical limiting structure are mutually perpendicular and are connected to form the L-shaped plate-shaped member. The plate-shaped member can reduce a distance between the light guide plate and the side wall of the backplane. Thus, the area of the light guide plate can be made to be larger, and then, optical quality of the edge of the backlight module is enhanced. Meanwhile, the L-shaped structure is simpler and is easier to make.

The buckle is directly molded on the plate-shaped horizontal limiting structure. The buckle can be directly molded on the horizontal limiting structure of the L-shaped limiting member by stamping without additionally adding other structures, and is easy to make.

The limiting member is made of plastic material. The limiting member made of the plastic material has good elasticity and low price, thus having low cost.

An LCD device comprises the aforementioned backlight module.

In the present disclosure, a limiting member is arranged between the edge of the light guide plate and the side wall of the backplane. One side of the limiting member abuts against the light guide plate, and the other side of the limiting member abuts against the side wall of the backplane. The limiting member is used for filling in a gap from the side wall of the backplane to the edge of the light guide plate. Thus, the horizontal liming of the light guide plate by directly using the limiting member is achieved. Then, the horizontal limiting of the light guide plate does not need riveting a fixed riveting column on the backplane. The structure of the backplane is simplified. Meanwhile, the positioning structure of the light guide plate is also simplified.

### BRIEF DESCRIPTION OF FIGURES

FIG. 1 is a simplified structural diagram of a typical LCD module.

FIG. 2 is a simplified structural diagram of a backlight module of example 1 of the present disclosure.

FIG. 3 is a simplified structural diagram of a limiting member in example 1 of the present disclosure.

FIG. 4 is a simplified structural diagram of a light guide plate in a typical backlight module.

FIG. 5 is a simplified structural diagram of a light guide plate of example 1 of the present disclosure.

FIG. 6 is a simplified structural diagram of an LCD module of example 2 of the present disclosure.

FIG. 7 is a simplified structural diagram of a limiting member in example 2 of the present disclosure.

Legends: 10. backplane; 20. front frame; 30. optical film; 40. light guide plate; 41. reflector plate; 42. groove; 50. LCD panel; 60. middle frame; 70. riveting column; 80. limiting member; 81. horizontal limiting structure; 82. vertical limiting structure; 83. buckle; 84. limiting lug head.

### DETAILED DESCRIPTION

The present disclosure is further described in accordance with the figures and the examples.

### The First Example

FIG. 2 shows a first example of the present disclosure. A backlight module comprises a backplane 10, a reflector plate 41 arranged in the backplane 10, a light guide plate 40 arranged on the reflector plate 41, and an optical film 30 arranged on the light guide plate 40, where the reflector plate 41 under the light guide plate 40, and the optical film 30 on the light guide plate 40 are limited by a limiting member 80.

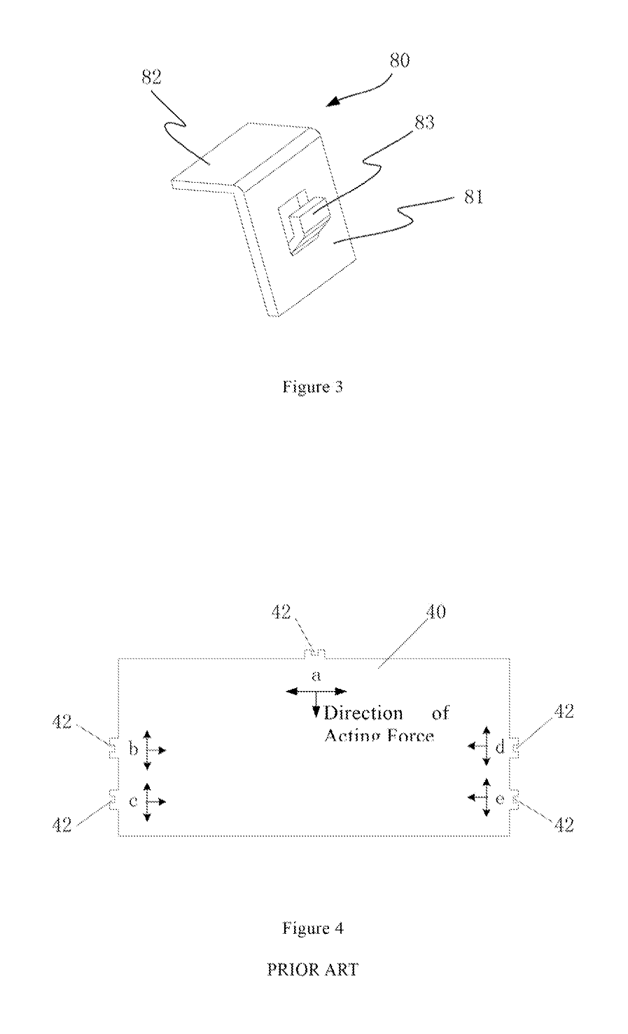

As shown in FIG. 3, the limiting member 80 comprises a horizontal limiting structure 81. As shown in FIG. 2, an inner side surface of the horizontal limiting structure 81 is a plane which forms a limiting plane directly abutting against an edge of the light guide plate 40 (a side surface at the edge that is perpendicular to a light emitting surface of the light guide plate). The limiting plane comes into surface contact with the edge of the light guide plate 40. Thus, a pressure of the limiting member 40 on the edge of the light guide plate 40 is prevented from being too high. The other side of the horizontal limiting structure 81 directly abuts a side wall 11 of the backplane 10. The limiting member 80 is used for filling in a gap from the side wall 11 of the backplane 10 to the edge of the light guide plate 40. Thus, a horizontal limiting of the light guide plate 40 by using limiting member 80 is achieved, and if this, the horizontal limiting of the flight guide plate 40 is achieved without a fixed riveting column riveted on the backplane 10.

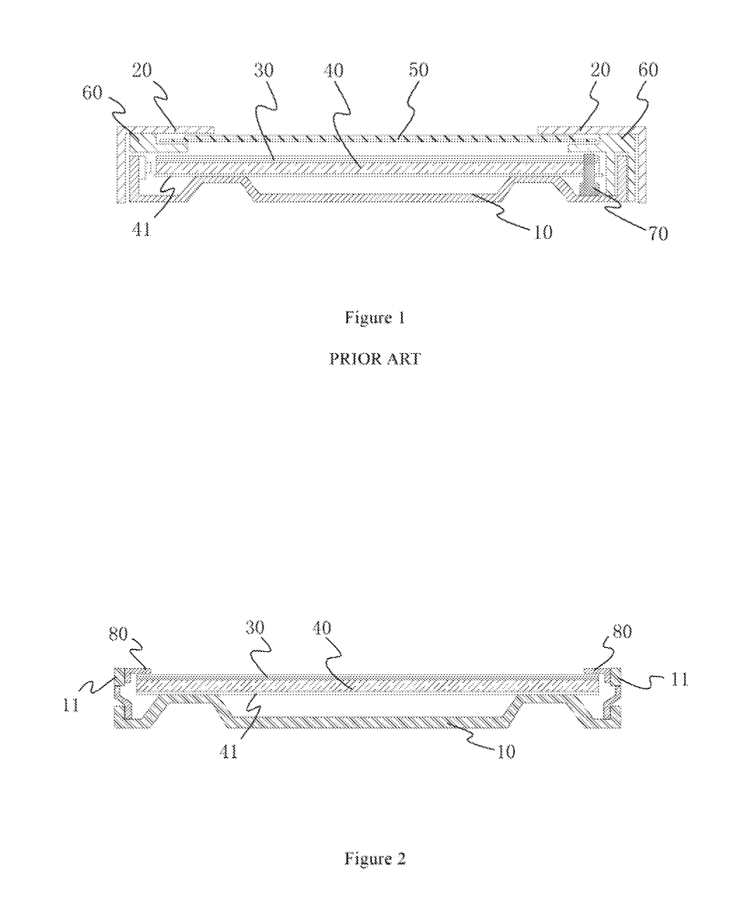

As shown in FIG. 2, the limiting member 80 also replaces the function of the middle frame 60 shown in FIG. 1 on the vertical limiting of the light guide plate 40. As shown in FIG. 3, the limiting member 80 further comprises a vertical limiting structure 82. The vertical limiting structure 82 is arranged on the light emitting surface of the light guide plate 40, i.e. on the optical film 30. A bottom part of the backplane 10 is matched with the vertical limiting structure to realize the vertical limiting function of the light guide plate 40. The vertical limiting structure 82 is positioned in a non-display area of the LCD device to avoid affecting brightness and uniformity of backlight and a display range of the LCD device.

The limiting member 80 is configured with a fixing structure to fix the limiting member 80 to the backplane 10. As shown in FIG. 3, the horizontal limiting structure 81 of the limiting member 80 is configured with an elastic buckle 83. Returned to FIG. 2, it is seen that the side wall 11 of the backplane 10 is configured with a clamping hole. The elastic buckle 83 on the limiting member 80 is clamped into the clamping hole. The limiting reliability of the member 80 is enhanced.

As shown in the figure, the limiting member 80 is an L-shaped plate-shaped member. The horizontal limiting structure 81 and the vertical limiting structure 82 are mutually perpendicular and are connected to form the L-shaped plate-shaped member. The buckle 83 is directly molded on the horizontal limiting structure 81 by stamping. Such a structure makes the manufacturing technology simple. For this example, the limiting member 80 can be made of plastic material, and the plastic material has convenience in molding, low price and good elasticity. The limiting member 80 can also be made of sheet metal members which also can be convenient to manufacturer.

As shown in FIG. 2, it is seen that the limiting member 80 can be directly pressed into a gap between the light guide plate 40 and the side wall 11 of the backplane 10. After the limiting member is pressed into the gap, the buckle 83 is clamped into the clamping hole of the side wall 11. The installation of the limiting member 80 is very simple.

As shown in FIG. 4, the applicant puts forward a scheme for reducing a crash of the light guide plate by the riveting column in U.S. patent application Ser. No. 13/376,657. In the scheme, the edge of the light guide plate 40 is configured with a lug head. The lug head is further configured with grooves 42 (a, b, c, d, e). The horizontal limiting of the light guide plate 40 is realized through riveting columns arranged at the grooves 42. As mentioned in the background, if the riveting columns are used, the light guide plate 40 is easy to damage. Using the riveting columns creates another disadvantage. Because of presence of the riveting columns, hotspots are easy to occur in a picture of the LCD device relative to positions near the riveting columns, especially, in LCD devices having a narrower frame. For this example, because the limiting mode of the riveting columns is not used, and the limiting member 80 with surface contact is used instead, as shown in FIG. 5, there is no need to cut the grooves on the light guide plate 40, so that the light guide plate 40 is a complete rectangular-shaped structure. The edge of the light guide plate 40 is flat. Thus, the optical quality of the edge of the picture of the LCD device is enhanced, and the phenomenon of generating the hotspots is reduced.

### The Second Example

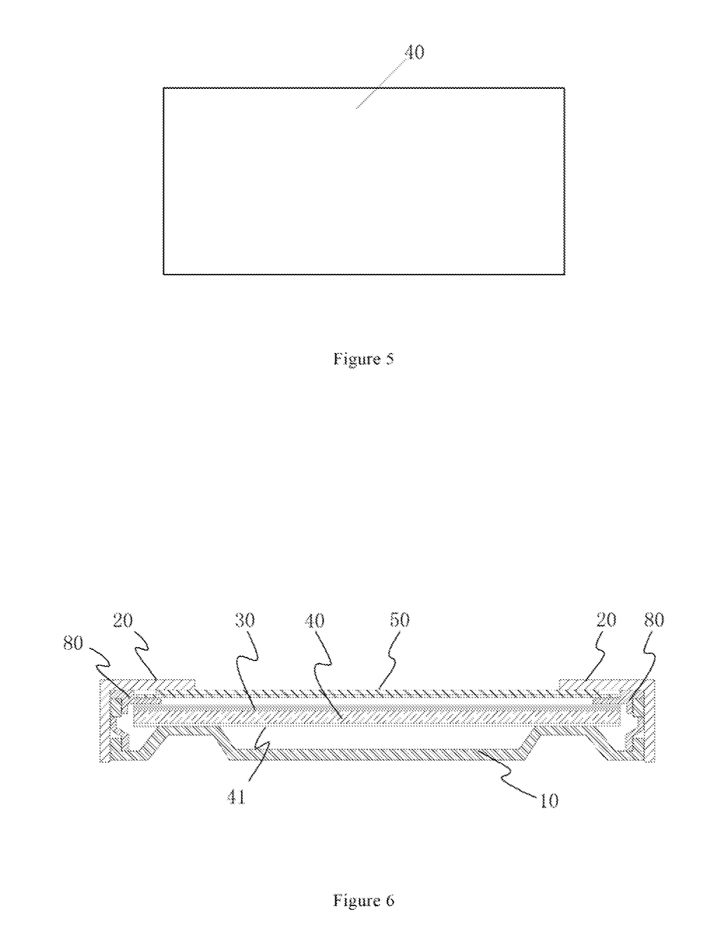

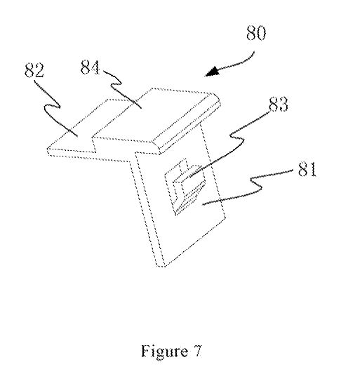

As shown in FIG. 6 and FIG. 7, a difference from the first example is that the vertical limiting structure 82 of the limiting member 80 is also configured with a limiting lug boss 84. The limiting lug head 84 is used for limiting the edge of the LCD panel 50 in the LCD device shown in FIG. 6, namely used for the horizontal limiting of the LCD panel 50. Meanwhile, the vertical limiting structure 82 can also be directly used for carrying the LCD panel 50 (namely that the LCD panel 50 is arranged on the vertical limiting structure). Thus, the limiting member 80 completely replaces the function of the middle frame 60 shown in FIG. 1. Therefore, in this example, the component of the middle frame is not used, and the structure of the LCD device is simplified. Meanwhile, the frame of the LCD device becomes narrower.

The present disclosure is described in detail in accordance with the above contents with the specific preferred examples. However, this present disclosure is not limited to the specific examples. For the ordinary technical personnel of the technical field of the present disclosure, on the premise of keeping the conception of the present disclosure, the technical personnel can also make simple deductions or replacements, and all of which should be considered to belong to the protection scope of the present disclosure.

We claim:

1. A backlight module, comprising:
a backplane,
a light guide plate arranged in the backplane, and
a limiting member for limiting the light guide plate, the limiting member comprising a horizontal limiting structure and a vertical limiting structure;
wherein the light guide plate is a rectangular-shaped structure, and an edge of the light guide plate is flat;
wherein the horizontal limiting structure is configured with a limiting plane, the limiting plane of the horizontal limiting structure abuts against an edge of the light guide plate, and the other side of the horizontal limiting structure abuts against a side wall of the backplane;
wherein the vertical limiting structure abuts against a light emitting surface of the light guide plate, and the horizontal limiting structure of the limiting member is configured with an elastic buckle relative to one side of the side wall of the backplane;
wherein the side wail of the backplane is configured with a clamping hole, and the limiting member is clamped into the clamping hole on the backplane through the elastic buckle of the limiting member.

2. A backlight module, comprising:
a backplane,
a light guide plate arranged in the backplane, and
a limiting member that limits the light guide plate;
wherein the limiting member comprises a horizontal limiting structure, and the horizontal limiting structure abuts against an edge of the light guide plate and a side wall of the backplane.

3. The backlight module of claim 2, wherein the light guide plate is a rectangular-shaped structure, and the edge of the light guide plate is flat; the horizontal limiting structure has a limiting plane, and the limiting plane comes into surface contact with the edge of the light guide plate.

4. The backlight module of claim 3, wherein the limiting member further comprises a vertical limiting structure, and the vertical limiting structure abuts against a light emitting surface of the light guide plate.

5. The backlight module of claim 2, wherein the limiting member further comprises a vertical limiting structure, and the vertical limiting structure abuts against the light emitting surface of the light guide plate.

6. The backlight module of claim 5, wherein the vertical limiting structure of the limiting member configured with a limiting lug head that limits the horizontal position of a liquid crystal display (LCD) panel of an LCD device; the vertical limiting structure carries the LCD panel; the limiting lug head limits an edge of the LCD panel.

7. The backlight module of claim 2, wherein the limiting member is configured with a fixing structure that fixes the limiting member to the backplane.

8. The backlight module of claim 7, wherein the fixing structure is an elastic buckle arranged on the horizontal limiting structure of the limiting member relative to one side of the side wall of the backplane; the side wall of the backplane is configured with a clamping hole, and the limiting member is clamped into the clamping hole on the backplane through the elastic buckle of the limiting member.

9. The backlight module of claim 8, wherein the limiting member is an L-shaped plate-shaped member; the horizontal limiting structure and the vertical limiting structure are mutually perpendicular and are connected to form the L-shaped plate-shaped member.

10. The backlight module of claim 9, wherein the buckle is directly molded on the plate-shaped horizontal limiting structure.

11. The backlight module of claim 2, wherein the limiting member is made of plastic material.

12. A liquid crystal display (LCD) device, comprising:
a backplane,
a light guide plate arranged in the backplane, and
a limiting member that limits the light guide plate;
wherein the limiting member comprises a horizontal limiting structure, and the horizontal limiting structure abuts against an edge of the light guide plate and a side wall of the backplane.

13. The backlight module of claim 12, wherein the light guide plate is a rectangular-shaped structure, and the edge of the light guide plate is flat; the horizontal limiting structure has a limiting plane, and the limiting plane comes into surface contact with the edge of the light guide plate.

14. The backlight module of claim 13, wherein the limiting member further comprises a vertical limiting structure, and the vertical limiting structure abuts against a light emitting surface of the light guide plate.

15. The backlight module of claim 14, wherein the vertical limiting structure of the limiting member is also configured with a limiting lug head for limiting the horizontal position of an LCD panel of an LCD device; the LCD panel is arranged on the vertical limiting structure, and an edge of the LCD panel is limited by the limiting lug head.

16. The backlight module of claim 12, wherein the limiting member is configured with a fixing structure for fixing the limiting member to the backplane.

17. The backlight module of claim 16, wherein the fixing structure is an elastic buckle arranged on the horizontal limiting structure of the limiting member relative to one side of the side wall of the backplane; the side wall of the backplane is configured with a clamping hole, and the limiting member is clamped into the clamping hole on the backplane through the elastic buckle of the limiting member.

18. The backlight module of claim 17, wherein the limiting member is an L-shaped plate-shaped member, and the horizontal limiting structure and the vertical limiting structure are mutually perpendicular and are connected to form the L-shaped plate-shaped member.

19. The backlight module of claim 18, wherein the buckle is directly molded on the plate-shaped horizontal limiting structure.

20. The backlight module of claim 12, wherein the limiting member is made of plastic material.
